(19) United States
(12) Patent Application Publication
(10) Pub. No.: US 2009/0253550 A1
(43) Pub. Date: Oct. 8, 2009

(54) Powertrain Having a Damper Installed Directly to Engine Output and Method of Assembling Same

(75) Inventors: Timothy J. Reinhart, Brownsburg, IN (US); William S. Reed, Greenfield, IN (US); Joel E. Mowatt, Zionsville, IN (US)

Correspondence Address: Quinn Law Group, PLLC, 39555 Orchard Hill Place, Suite 520, Novi, MI, 48375, US

(73) Assignees: GM GLOBAL TECHNOLOGY OPERATIONS, INC., Detroit, MI (US); GENERAL MOTORS CORPORATION, Detroit, MI (US)

(21) Appl. No.: 12/234,866

(22) Filed: Sep. 22, 2008

Related U.S. Application Data
(60) Provisional application No. 61/041,936, filed on Apr. 3, 2008.

(51) Int. Cl. B60K 6/30; B23P 11/00

(52) U.S. Cl. 477/3; 29/428

(57) ABSTRACT

A hybrid powertrain includes an engine driving an engine output member, such as a crankshaft. A damper is directly connected to the engine output member, and a transmission input shaft is directly connected to the damper, for common rotation therewith. A dry damper is configured to allow the hybrid powertrain to be characterized by a lack of either a flexplate or a flywheel. A method of manufacturing a hybrid powertrain is also provided, including assembling a fully-functional hybrid transmission at a first manufacturing facility and assembling a fully-functional engine by joining a dry damper to an engine at a second manufacturing facility different from the first. Each of the fully-functional engine and hybrid transmission may be tested separately from the other. The fully-functional engine and hybrid transmission may then be shipped to a common assembly facility, and dry-mated at the common assembly facility, forming an assembled hybrid powertrain.

### CROSS-REFERENCE TO RELATED APPLICATIONS

This application claims the benefit of U.S. Provisional Application No. 61/041,936, filed Apr. 3, 2008, which is hereby incorporated by reference in its entirety.

### TECHNICAL FIELD

The present invention relates to vehicular drivetrains, and more particularly, to transmissions for hybrid and hybrid-type vehicles.

### BACKGROUND OF THE INVENTION

Internal combustion engines, particularly those of the reciprocating piston type, currently propel most vehicles. Such engines are relatively efficient, compact, lightweight, and inexpensive mechanisms by which to convert highly concentrated energy in the form of fuel into useful mechanical power.

Typically, a vehicle is propelled by such an engine, which is started from a cold state by a small electric motor and relatively small electric storage batteries, then quickly placed under the loads from propulsion and accessory equipment. Such an engine is also operated through a wide range of speeds and a wide range of loads and typically at an average of approximately a fifth of its maximum power output.

A vehicle transmission typically delivers mechanical power from an engine to the remainder of a drive system, such as fixed final drive gearing, axles and wheels. A typical mechanical transmission allows some freedom in engine operation, usually through alternate selection of five or six different drive ratios, a neutral selection that allows the engine to operate accessories with the vehicle stationary, and clutches or a torque converter for smooth transitions between driving ratios and to start the vehicle from rest with the engine turning. Transmission gear selection typically allows power from the engine to be delivered to the rest of the drive system with a ratio of torque multiplication and speed reduction, with a ratio of torque reduction and speed multiplication known as overdrive, or with a reverse ratio.

To operate properly, the transmission usually requires a supply of pressurized fluid, such as conventional transmission oil. The pressurized fluid may be used for such functions as cooling, lubrication, and, in some cases, operation of the torque transfer devices. The lubricating and cooling capabilities of transmission oil systems impact the reliability and durability of the transmission. Additionally, multi-speed transmissions require pressurized fluid for controlled engagement and disengagement of the torque transmitting mechanisms that operate to establish the speed ratios within the internal gear arrangement.

In hybrid vehicles, alternative power is available to propel the vehicle, minimizing reliance on the engine for power, thereby increasing fuel economy. Since hybrid vehicles can derive their power from sources other than the engine, engines in hybrid vehicles can be turned off while the vehicle is propelled by the alternative power source(s). For example, electrically variable transmissions alternatively rely on electric motors housed in the transmission to power the vehicle's driveline.

An electric generator can transform mechanical power from the engine into electrical power, and an electric motor can transform that electric power back into mechanical power at different torques and speeds for the remainder of the vehicle drive system. These functions may be combined into a single electric machine, a motor/generator. An electric storage battery used as a source of power for propulsion may also be used, allowing storage of electrical power created by the generator, which may then be directed to the electric motor for propulsion or used to power accessory equipment.

A series hybrid system allows the engine to operate with some independence from the torque, speed and power required to propel a vehicle, so the engine may be controlled for improved emissions and efficiency. Such a system may also allow the electric machine attached to the engine to act as a motor to start the engine. This system may also allow the electric machine attached to the remainder of the drive train to act as a generator, recovering energy from slowing the vehicle and storing it in the battery by regenerative braking.

An electrically variable transmission in a vehicle can simply transmit mechanical power from an engine input to a final drive output. To do so, the electric power produced by one motor/generator balances the electrical losses and the electric power consumed by the other motor/generator. By using the above-referenced electrical storage battery, the electric power generated by one motor/generator can be greater than or less than the electric power consumed by the other. Electric power from the battery can allow both motor/generators to act as motors. Both motors can sometimes act as generators to recharge the battery, especially in regenerative vehicle braking.

A power-split transmission can use what is commonly understood to be “differential gearing” to achieve a continuously variable torque and speed ratio between input and output. An electrically variable transmission can use differential gearing to send a fraction of its transmitted power through a pair of electric motor/generators. The remainder of its power flows through another, parallel path that is mechanical.

One form of differential gearing, as is well known to those skilled in this art, may constitute a planetary gear set. However, it is possible to construct this invention without planetary gears, as by using bevel gears or other gears in an arrangement where the rotational speed of at least one element of a gear set is always a weighted average of speeds of two other elements.

A hybrid electric vehicle transmission system may include one or more electric energy storage devices. The typical device is a chemical electric storage battery, but capacitive or mechanical devices, such as an electrically driven flywheel, may also be included. Electric energy storage allows the mechanical output power from the transmission system to the vehicle to vary from the mechanical input power from the engine to the transmission system. The battery or other device also allows for engine starting with the transmission system and for regenerative vehicle braking.

### SUMMARY OF THE INVENTION

A hybrid powertrain is provided, including an engine driving an engine output member, such as a crankshaft. A damper is directly connected to the engine output member, and a transmission input shaft is directly connected to the damper, for common rotation therewith. In one embodiment, the damper is a dry damper, and the hybrid powertrain may be characterized by a lack of either a flexplate or a flywheel. The transmission input shaft is directly connected to the damper without the use of bolts or other fasteners.

A method of manufacturing a hybrid powertrain is also provided. The method includes assembling a fully-functional hybrid transmission at a first manufacturing facility. A fully-functional engine is assembled at a second manufacturing facility by joining a damper to an engine output. The second manufacturing facility may be different from the first manufacturing facility. Both the fully-functional engine and transmission may be tested at the respective manufacturing facility, prior to assembly of the hybrid powertrain or mating of the engine and transmission. The fully-functional engine and the fully-functional hybrid transmission are then shipped to a common assembly facility. The fully-functional engine and hybrid transmission may then be dry-mated at the common assembly facility, forming an assembled hybrid powertrain.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic representation of a powertrain into which one embodiment of the present invention may be incorporated;

FIG. 2A is a schematic cross section of the single-point interface between the engine and transmission of the powertrain shown schematically in FIG. 1; and

FIG. 2B is a close up of the view shown in FIG. 2A, better demonstrating the engine output, dry damper, and the dry-mating power transfer interface between the damper hub and transmission input.

### DESCRIPTION OF PREFERRED EMBODIMENTS

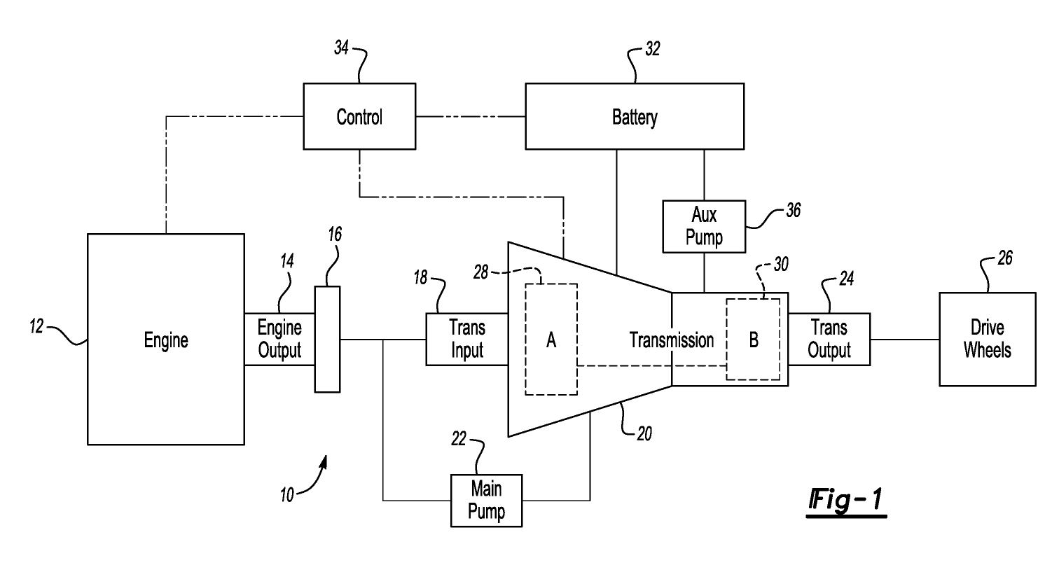

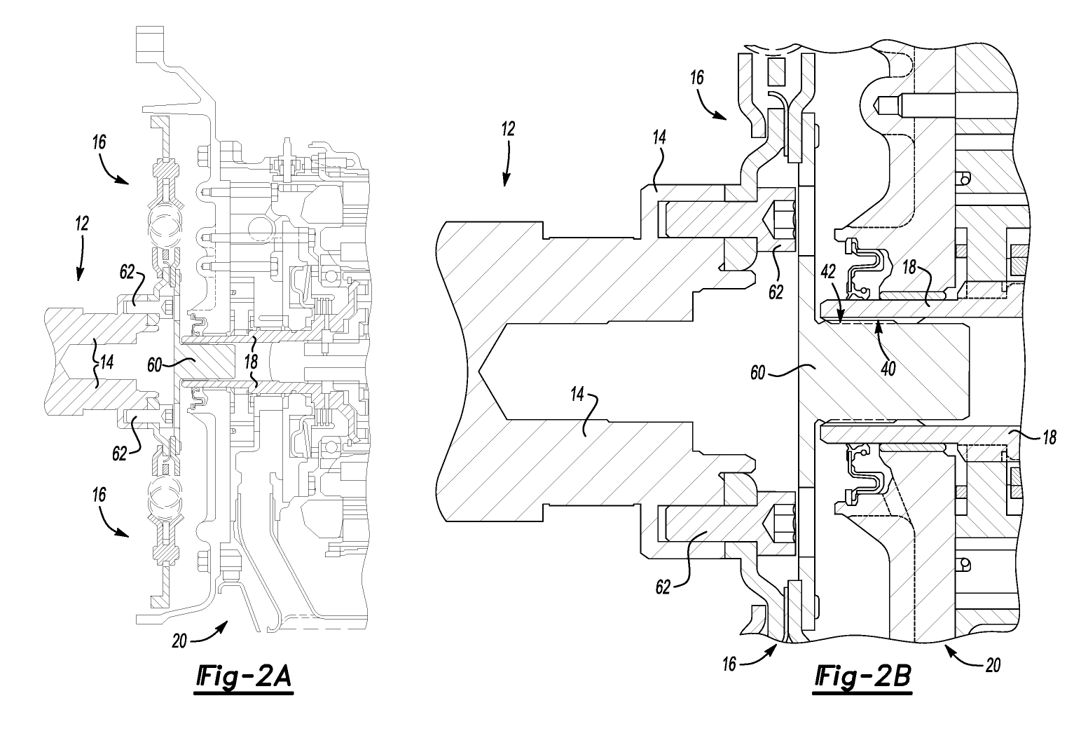

With reference to FIG. 1, there is shown a schematic diagram of a hybrid powertrain 10 into which the claimed invention may be incorporated. The hybrid powertrain 10 includes an engine 12, which may be any type of internal combustion engine known in the art. Engine 12 turns an engine output 14, which transmits or outputs the driving power produced by the engine 12. Driving power is then transferred through a transmission input shaft 18 into a transmission 20. A damper, in this embodiment a dry damper 16, is interposed between the engine output 14 and the transmission input shaft 18. Input shaft 18 and dry damper 16 are described in more detail below, with reference to FIGS. 2A and 2B.

Input shaft 18 may be operatively connectable to planetary gear members (not shown) or to torque transfer devices (not shown) within transmission 20. The transmission 20 may be an electrically variable transmission, a one or two-mode input split transmission, a two-mode transmission with input-split and compound-split, or another hybrid transmission known to those having ordinary skill in the art.

Transmission 20 utilizes input shaft 18 to receive power from the vehicle engine 12 and a transmission output 24 to deliver power to drive the vehicle through one or more drive wheels 26. In the embodiment shown in FIG. 1, transmission 20 includes a first motor 28 and a second motor 30. Each of the motors 28 and 30 is a motor/generator capable of both converting electric power into mechanical power and converting mechanical power into electric power. The first motor 28 may also be referred to as motor A, and second motor 30 may be referred to as motor B.

The fluid in transmission 20 is pressurized by a main pump 22, which is directly or indirectly driven by power output from the engine 12. The pressurized fluid may be used for such functions as cooling, lubrication, and, in some cases, operation of the torque transfer devices.

The transmission 20 may utilize one or planetary gear sets (not shown), and may utilize one or more clutches (not shown) to provide input split, compound split, and fixed ratio modes of operation. The planetary gear sets may be simple or may be individually compounded.

The motors 28 and 30 are operatively connected to a battery 32, an energy storage device, so that the battery 32 can accept power from, and supply power to, the first and second motor/generators 28 and 30. A control system 34 regulates power flow among the battery 32 and the motors 28 and 30 as well as between the motors 28 and 30.

As will be apparent to those having ordinary skill in the art, the control system 34 may further control the engine 12 and operation of the transmission 20 to select the output characteristics transferred to the drive wheels 26. Control system 34 may incorporate multiple control methods and devices.

As will further be recognized by those having ordinary skill in the art, battery 32 may be a single chemical battery or battery pack, multiple chemical batteries, or other energy storage device suitable for hybrid vehicles. Other electric power sources, such as fuel cells, that have the ability to provide, or store and dispense, electric power may be used in place of battery 32 without altering the concepts of the present invention.

In some modes of operation for the hybrid powertrain 10, the engine 12 may shut down or turn off completely. This may occur when the control system 34 determines that conditions are suitable for drive wheels 26 to be driven, if at all, solely by alternative power from one or both of motors 28 and 30, or during periods of regenerative braking. While the engine 12 is shut down, the main pump 22 is not being driven, and is therefore not providing pressurized fluid to transmission 20. Hybrid powertrain 10 may therefore include an auxiliary pump 36, which may be powered by the battery 32 to provide pressurized fluid to transmission 20 when additional pressure is required.

Referring to FIGS. 2A and 2B, there is shown one possible embodiment of a portion of the power train 10 shown schematically in FIG. 1. More specifically, FIG. 2A shows a cross-sectional view of the interface area between the engine 12 and the transmission 20, and FIG. 2B shows an enlarged view of the power transfer interface between the engine 12 and the transmission 20. In this embodiment, the engine 12 is outputting power through the engine output 14, which is a crankshaft.

The dry damper 16 is a non-fluid filled damper, which may be bolted directly to the engine output 14. Directly connecting engine output 14 to dry damper 16 allows operation without using an intermediate flexplate or a flywheel. Dry damper 16 is less susceptible to ballooning or axial movement versus a wet (fluid filled) damper, which may act as a pressure vessel under high speed.

Ballooning refers to growing in the axial direction due to expansion of the pressure vessel under pressure. In this embodiment, dry damper 16 is a spring isolator that has two stages of spring rates (for 1st and 2nd stage spring rates) and a hysteresis value that is used as a tuning feature for noise, vibration, and harshness. Those having ordinary skill in the art will recognize various dampers which may be used within the scope of the claims.

Because of the elimination of a flexplate, the dry damper 16 can bolt directly to the engine output 14 at the engine plant. Removal of the intermediate flexplate or flywheel reduces the number of bolted connections (crankshaft-to-damper, instead of crankshaft-to-flexplate and flexplate-to-damper) and therefore may ease the assembly process.

Alternative designs may have mounted the damper inside of the transmission, which requires that the transmission plant install the damper. The vehicle assembly plant would then mate the damper to the engine 12 when it is already inside the transmission 20 input housing, which is a more-difficult assembly process.

Dry damper 16 is mounted to engine output 14 by crank bolts 62. In this embodiment, dry damper 16 includes a damper hub 60 as a damper output member. Power is transferred from the damper hub 60 to the transmission 20 by the hollow, internally-splined input shaft 18.

The input shaft 18 has internal dry splines 40 which may be mated to external dry splines 42 on the damper hub 60. This direct, single-point connection between the engine 12 and the transmission 20 does not require that input shaft 18 be bolted to the damper hub 60. Therefore, the connection between the engine 12 and transmission 20 is characterized by a lack of bolts or other fasteners or hardware. Splines 40 and 42 are maintained as dry splines by sealing them against pressurized transmission fluid contained in the transmission 20.

Dry splines, as opposed to wet splines, are not continuously in fluid communication with transmission fluid or engine oil. Dry splines may, however, have grease applied to one or both sets of splines before installation. Such pre-installation grease assists in the dry-mating process and may provide any necessary lubrication for the life of the parts. In this embodiment, sealing against transmission fluid is accomplished with a freeze plug, which is press-fit into the interior of input shaft 18. However, as will be recognized by those having ordinary skill in the art, sealing could also be accomplished by an input shaft that is not completely hollow.

In the embodiment shown in FIGS. 2A and 2B, engine 12 and transmission 20 are mated at a single, non-fluidly filled interface point (having only pre-installation grease on the dry splines). In the manufacturing process, this allows dry-mating the input shaft 18 to the damper hub 60 along the splines 40 and 42; which may reduce the difficulty, time, and cost of manufacturing and assembling the hybrid powertrain 10. Furthermore, the dry-mating process allows the transmission 20 to be filled with transmission fluid prior to mating the engine 12 and transmission 20, possibly even prior to shipping the transmission 20 to the final assembly point.

The dry-mating process is configured to allow transmission 20 to be fully assembled and then tested at the transmission assembly facility, prior to assembly of the hybrid powertrain 10. If transmission 20 is tested to be fully and properly operational, it may then be mated to the engine 12. The dry-mating step may occur after shipping or transferring the transmission 20 to a different facility for assembly of the hybrid powertrain 10.

The single-point interface may also allow the engine 12 to be fully assembled—by joining the dry damper 16 to the crankshaft—and tested as a fully-functional unit. If the engine 12 is tested as satisfactory, it may then be transferred to the assembly facility and dry-mated to the fully-functional transmission 20 to substantially complete assembly of the hybrid powertrain 10.

While the best modes for carrying out the claimed invention have been described in detail, those familiar with the art to which this invention relates will recognize various alternative designs and embodiments for practicing the invention within the scope of the appended claims.

1. A hybrid powertrain, comprising:
an engine driving an engine output member;
a damper directly connected to said engine output member; and
a transmission input shaft directly connected to said damper, for common rotation therewith.

2. The hybrid powertrain of claim 1, wherein said engine output member is characterized by the absence of a flexplate and a flywheel.

3. The hybrid powertrain of claim 2, wherein said damper is a dry damper.

4. The hybrid powertrain of claim 3, wherein said direct connection between said transmission input shaft and said damper is characterized by the absence of a bolt.

5. A method of manufacturing a hybrid powertrain, comprising:
assembling a fully-functional hybrid transmission at a first manufacturing facility;
joining a damper to an engine to form a fully-functional engine at a second manufacturing facility different from said first manufacturing facility;
transferring said fully-functional engine and said fully-functional hybrid transmission to a common assembly facility; and
dry-mating said fully-functional engine to said fully-functional hybrid transmission at said common assembly facility.

6. The method of claim 7, further comprising testing said fully-functional engine prior to transferring said fully-functional engine to said common assembly facility.

7. The method of claim 6, wherein said common assembly facility is different from both said first manufacturing facility and said second manufacturing facility.

8. The method of claim 7, further comprising testing said fully-functional hybrid transmission prior to transferring said fully-functional hybrid transmission to said common assembly facility.

9. The method of claim 8, wherein said dry-mating said fully-functional engine to said fully-functional hybrid transmission is characterized by the absence of bolting said fully-functional engine to said fully-functional hybrid transmission.
